(19) United States
(12) Patent Application Publication
(10) Pub. No.: US 2024/0198842 A1
(43) Pub. Date: Jun. 20, 2024

(54) Method and device for processing a message received by an electronic client from a conversational agent

(71) Applicant: ORANGE, Issy-les-Moulineaux (FR)

(72) Inventors: Emmanuel Le Huerou, CHATILLON CEDEX (FR); François Toutain, CHATILLON CEDEX (FR); Michael Pontiggia, CHATILLON CEDEX (FR)

(21) Appl. No.: 18/542,896

(22) Filed: Dec. 18, 2023

(30) Foreign Application Priority Data
Dec. 19, 2022 (FR) 2213742

(51) Int. Cl. B60L 53/66; B60L 53/30; B60L 53/65; H04L 51/02

(52) U.S. Cl. CPC B60L 53/66; B60L 53/305; B60L 53/65; H04L 51/02

(57) ABSTRACT

A method for processing a message received by an electronic client from a conversational agent, the method being implemented by a processing device and including: obtaining, from the conversational agent, the message including at least one management rule and at least one associated action; executing the at least one associated action depending on a result of at least one evaluation of the at least one management rule.

### 1. CROSS REFERENCE TO RELATED APPLICATION

This application claims priority to and the benefit of French Patent Application No. FR 2213742, filed Dec. 19, 2022, the entire content of which is hereby incorporated by reference.

### 2. FIELD OF THE DISCLOSURE

The present disclosure relates to the field of telecommunications and relates more particularly to digital services provided to a user by a conversational agent.

### 3. PRIOR ART

The use of conversational agents is increasingly widespread and is revolutionizing the client relationship. These computer programs analyse, in real time, the messages/questions (either in natural language or through predefined choices) sent by a user, for example via an enriched messaging protocol such as the GSMA Rich Communication Services/Rich Communication Suite (RCS) standard, and provide a suitable response thereto.

Conversational agents are rule-based, that is to say that they implement rules which make it possible to determine the life cycle of a transaction (set of messages which are exchanged during the same communication session between a conversational agent and a client) depending on states and events (state machine operation). For example, a rule on the transition from one state to another may provide a condition, which is evaluated in the context of execution of the conversational agent. Concretely, any information which derives from the service infrastructure of the conversational agent may feed into this context and may therefore be taken into account when evaluating a condition.

However, in some situations, it may be advantageous to take into account the context of execution of the client of the conversational agent, that is to say of the computer and/or hardware module (mobile application, web interface, messaging client, etc.) which is linked to the user.

It is clear that there is no such option at present. There is therefore a need to invent new ways for a conversational agent and a client to interact which make it possible to take into account a context of execution of the client of the conversational agent.

### 4. SUMMARY

An aspect of the present disclosure improves the prior art and proposes, to that end, a method for processing a message received by an electronic client from a conversational agent, said method being implemented by a processing device and characterized in that it comprises:
a step of obtaining, from said conversational agent, said message comprising at least one management rule and at least one associated action;
a step of executing said at least one associated action depending on a result of at least one evaluation of said at least one management rule.

Advantageously, an aspect of the disclosure makes it possible for a client of a conversational agent to execute an action depending on the result of the evaluation of one or more conditions/rules which are obtained from the conversational agent. This embodiment makes it possible, for example, for the client of the conversational agent to verify all or some of the one or more conditions (management rules) relating to the progression of a transaction/of a dialogue with the conversational agent (life cycle of the transaction). What is meant by “dialogue” is all of the electronic messages exchanged during a session between a conversational agent and one of its clients.

Note that the session may comprise a single message sent by the conversational agent.

What is meant by “message” is a set of data which are intended to be transmitted by a computer system. The message may be textual, in the form of a data stream or of one or more files.

What is meant by “management rule” is all of the business rules associated with a client of the conversational agent. The management rules may, for example, comprise conditions (location, speed, temperature, altitude etc.) and/or thresholds to be complied with (for example, a predefined period). Note that the management rules may take the form of regular expressions and/or of an interpretable computer code.

What is meant by “conversational agent” is a computer dialogue machine which is able to dialogue with a client (smart object, computer, dashboard of a vehicle etc.). The conversational agent generates messages to the client and interprets the responses sent in return in order to respond to the requests/needs reported by the client. Note that the dialogue may occur verbally and/or through a human-machine interface (screen, keyboard etc.).

According to one particular implementation of the disclosure, a method as described above is characterized in that said evaluation of said at least one management rule is carried out depending on at least one context datum for said client.

Advantageously, this implementation makes it possible for the client to take into account its context when evaluating the obtained management rules. For example, the management rules may comprise conditions linked to the location of the client (its proximity and/or its position/its coordinates). Note that the context data may be obtained by the client and/or via third-party electronic devices.

Furthermore, this embodiment makes it possible to limit the costs which are inherent in the execution of the conversational agent by letting the client confirm some conditions of the transaction which are linked to its context. Specifically, such an implementation makes it possible not to have to deploy an infrastructure dedicated to transmitting context data for the client to the conversational agent. In addition, the conversational agent does not have to process the context data for the client, which makes it possible to optimize the use of the memory and/or of the processor of the conversational agent. Finally, the context data for the client are processed locally, thus preserving their personal character, without disclosure to a remote device.

What is meant by “context datum” is all of the data collected and/or generated by a client of a conversational agent. For example, the context data may be generated on the basis of the data collected by the client.

According to one particular implementation of the disclosure, a method as described above is characterized in that said at least one result is obtained from a second human-machine interface of said client after said at least one management rule is rendered through a first human-machine interface of said client.

This implementation makes it possible for the user of the client, for example the user of an on-board computer of a vehicle or a mobile terminal (smartphone), to evaluate one or more rules/conditions obtained from the conversational agent. Concretely, the rules are previously rendered (verbally and/or graphically) to the user by the client via a first human-machine interface then evaluated by the latter.

Once the rules have been evaluated, the one or more results are transmitted to the client by the user via a second human-machine interface.

Note that the first and the second human-machine interfaces may be one and the same human-machine interface.

According to one particular implementation of the disclosure, a method as described above is characterized in that said at least one evaluation is conditioned by the result of a confirmation step performed by a user through a human-machine interface of said client.

This implementation makes it possible for a user to confirm or not confirm the evaluation of a rule/condition obtained from the conversational agent. This implementation also makes it possible, when the evaluation of the management rule requires the use of a sensitive/personal datum (for example, a location, an identity etc.), to obtain consent on the part of the user. This consent may, for its part, be requested at the start of a transaction and/or during a transaction.

According to one variant of this implementation, the consent may alternatively or additionally correspond to consent of the user to the use of a type of conversational agent (for example, of payment type) and/or to a particular conversational agent.

According to one particular implementation of the disclosure, a method as described above is characterized in that the obtainment step further comprises obtaining at least one description datum for said at least one management rule.

Advantageously, this implementation makes it possible to associate a description datum with a management rule. Concretely, the description datum may describe the associated management rule and be rendered to the user via a human-machine interface of the client. The description datum may correspond to a text and/or an image and/or a sound (for example, an RCS (Rich Communication Services) rich card).

According to one particular implementation of the disclosure, a method as described above is characterized in that the step of executing said at least one action is conditioned by the result of a confirmation step performed by a user through a human-machine interface of said client.

This implementation makes it possible for a user to confirm or not confirm the execution of an action.

According to one particular implementation of the disclosure, a method as described above is characterized in that said message is of RCS type.

The RCS protocol is an enriched messaging protocol defined by the GSMA consortium. This protocol makes it possible, inter alia, to construct a conversational agent. The message may be compliant with the GSMA FNW.11 standard. Concretely, a new type of message may be introduced, for example, in section 2.4 (RCSMessageType), according to the below format:
Property: conditionalAction
Type: object
Mandatory: no
Description: This is the conditionalAction JSON object, containing one or several rules to be evaluated by the client software, and one or several actions to be performed following positive evaluation.

Alternatively, the message may be an XMPP message or generally any message which is able to make a dialogue between a conversational agent and an electronic client of the conversational agent possible.

An aspect of the disclosure also relates to a device for processing a message received by an electronic client from a conversational agent, characterized in that it comprises:
a module for obtaining, from said conversational agent, said message comprising at least one management rule and at least one associated action;
a module for executing said at least one associated action depending on a result of at least one evaluation of said at least one management rule.

The term “module” may correspond to a software component as well as to a hardware component or to a set of hardware and software components, a software component itself corresponding to one or more computer programs or subroutines or, more generally, to any element of a program which is able to implement a function or a set of functions as described for the modules concerned. In the same way, a hardware component corresponds to any element of a hardware assembly which is able to implement a function or a set of functions for the module concerned (integrated circuit, chip card, memory card etc.).

According to one particular implementation of the disclosure, a device as described above is characterized in that it is contained in a terminal and/or in a vehicle.

An aspect of the disclosure also relates to a computer program comprising instructions for implementing the above method according to any one of the particular embodiments described above when said program is executed by a processor. The method may be implemented in various ways, notably in hard-wired form or in software form. This program may use any programming language and be in the form of source code, object code or intermediate code between source code and object code, such as in a partially compiled form, or in any other desirable form.

An aspect of the disclosure also targets a computer-readable storage medium or information medium containing instructions of a computer program as mentioned above. The storage media mentioned above may be any entity or device which is capable of storing the program. For example, the medium may comprise a storage means, such as a ROM, for example a CD-ROM or a microelectronic circuit ROM, or indeed a magnetic storage means, for example a hard disk. Moreover, the storage media may correspond to a transmissible medium such as an electrical or optical signal, which may be routed via an electrical or optical cable, by radio or by other means. The programs according to an aspect of the disclosure may, in particular, be downloaded from the Internet.

Alternatively, the storage media may correspond to an integrated circuit into which the program is incorporated, the circuit being suitable for executing, or for being used when executing, the method in question.

This processing device and this computer program have features and advantages which are analogous to those described above in relation to the processing method.

### 5. BRIEF DESCRIPTION OF THE DRAWINGS

Other features and advantages will become more clearly apparent on reading the following description of particular embodiments, which are given by way of mere illustrative and non-limiting examples, and the appended drawings, in which:

FIG. 1 illustrates an example of an environment of implementation of according to one particular aspect of the disclosure;

FIG. 2 schematically illustrates an example of an architecture of a device which is suitable for implementing the processing method according to one particular aspect of the disclosure;

FIG. 3 illustrates the main steps of the processing method according to one particular aspect of the disclosure.

### 6. DETAILED DESCRIPTION OF ILLUSTRATIVE EMBODIMENTS

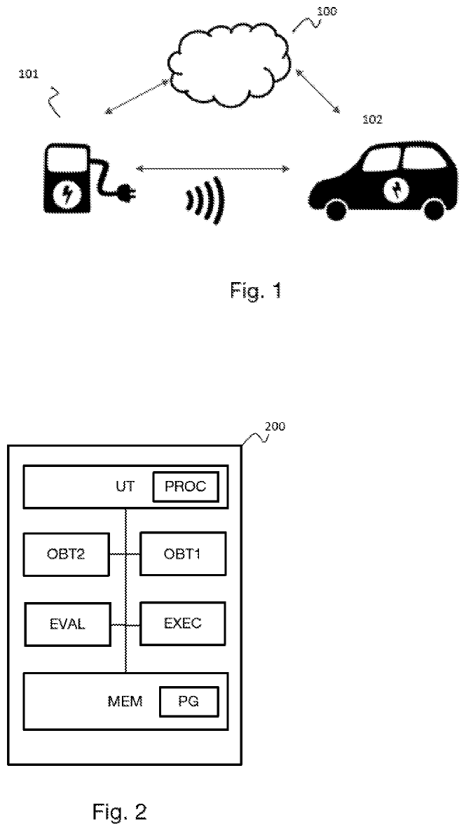

FIG. 1 illustrates an example of an environment of implementation an aspect of the disclosure. FIG. 1 more particularly illustrates a terminal 102 (for example, a smart object) which is able to implement the processing method according to one particular embodiment. The terminal 102 corresponds, in this example, to an on-board computer of a connected electric car (client of the conversational agent within the meaning of the disclosure). According to one particular embodiment of the disclosure, the method may be implemented by any type of smart terminal possessing the architecture of a computer, such as, for example and non-limitingly, a games console, a television, a cash machine, a router, a tablet, a personal computer, a smartphone etc.

The environment of implementation of an aspect of the disclosure also comprises a conversational agent which, in this example, is hosted/executed in an electrical charging station 101. The conversational agent makes it possible to manage the actions linked to charging an electric vehicle at the station (planning a charge, the charging itself, payment etc.). Note that the conversational agent may also be hosted/executed on a server located in the network and connected to the charging station 101.

According to one particular embodiment of the disclosure, the conversational agent may be implemented by any type of smart terminal possessing the architecture of a computer, such as, for example and non-limitingly, a server, a gateway, a games console, a television, an automatic cash dispenser, a router, a tablet, a personal computer, a smartphone etc.

According to one particular embodiment of the disclosure, the conversational agent may be partially or wholly distributed between the electrical charging station and a platform (i.e. a server) located in the network (which is not shown).

The communications between the electrical charging station 101 and the dashboard 102 are, for example, performed via the (for example, IP and/or circuit) network 100 and RCS (Rich Communication Services) technology.

According to one particular embodiment of the disclosure, the electric vehicle 102 may dialogue directly with the conversational agent of the charging station 101. The communication may be wired, via, for example, PLC (power-line communication) technology, when the electric vehicle 102 is connected to the station 101, or indeed wireless, via, for example, Bluetooth®, Wi-Fi® and/or cellular radiotelephony technologies.

According to one particular embodiment of the disclosure, the client of the conversational agent 102 may be partially or wholly distributed between the dashboard of the electric car and a smartphone (which is not shown) which is associated with it.

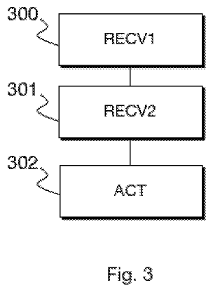

FIG. 2 illustrates a device 200 configured to implement the processing method according to one particular embodiment. According to one particular embodiment of the disclosure, the device 200 has the conventional architecture of a computer, and notably comprises a memory MEM and a processing unit UT, which is equipped, for example, with a processor PROC and controlled by the computer program PG stored in the memory MEM. The computer program PG comprises instructions for implementing the steps of the processing method as described above when the program is executed by the processor PROC. On initialization, the code instructions of the computer program PG are, for example, loaded into a memory before being executed by the processor PROC. The processor PROC of the processing unit UT notably implements the steps of the processing method according to any one of the particular embodiments described with reference to FIGS. 1 and 3, according to the instructions of the computer program PG.

The device 200 comprises a module OBT1 which is able to obtain one or more management rules and one or more associated actions from a conversational agent.

According to one particular embodiment, the module OBT1 is also able to obtain at least one description datum associated with a management rule.

According to one particular embodiment of the disclosure, the device 200 may further comprise a module OBT2 which is able to obtain one or more results of the evaluation of one or more rules which are obtained via the module OBT1.

According to one particular embodiment of the disclosure, the device 200 may also comprise a module EVAL which is able to evaluate one or more rules which are obtained via the module OBT1.

The device 200 further comprises a module EXEC which is able to execute at least one action associated with a management rule for which the result of its evaluation obtained via the module OBT2 is positive.

According to one particular embodiment, the modules OBT1 and OBT2 are able to communicate (send and/or receive messages) via an IP and/or circuit network. According to one particular embodiment, the modules OBT1 and OBT2 are one and the same module.

According to one particular embodiment, the device 200 may comprise a digital storage module (for example, the memory MEM) which is able to store the management rules which are obtained from a conversational agent via the module OBT1.

According to one particular embodiment, the device 200 comprises a first human-machine interface module (which is not shown) which is able to render, to a user, one or more management rules which are obtained via the module OBT1.

According to one particular embodiment, the device 200 comprises a second human-machine interface module (which is not shown) which is able to obtain confirmation and/or consent on the part of a user. The confirmation may correspond to the confirmation of a condition of a management rule and the consent to an agreement to the use of a personal datum of the user.

According to one particular embodiment, the first and the second human-machine interface modules are one and the same module.

FIG. 3 illustrates steps of the processing method according to one of the particular embodiments of the disclosure which were presented above, the method being executed on the terminal 102 (dashboard of an electric car) described in FIG. 1.

The terminal 102 (client within the meaning of the disclosure) communicates, for example, with the conversational agent contained in the charging station 101 via the network 100 and RCS (Rich Communication Services) technology.

During a first step 300, the method obtains, in a message, management rules and associated actions from the conversational agent of the charging station 101.

According to one particular embodiment, the message may be a message referred to as a “service message”, that is to say which is not visible to the user of the terminal 102 (not rendered to the user by the terminal 102).

According to one particular embodiment, the message may further comprise a datum referred to as a “dialogue datum” which is able to be rendered (graphically and/or verbally) via a human-machine interface of the terminal 102. This dialogue datum comprises, for example, a list of the services which are rendered by the conversational agent and, more generally, all of the information relating thereto. Furthermore, it may comprise an operating mode, information linked to a service, a response of the conversational agent to a message sent by the terminal 102 etc. The dialogue datum may also correspond to a text and/or an image and/or a video and/or an RCS rich card (which is or is not dynamic, that is to say modified over the course of time) and/or selectable/clickable graphical elements (URLs (Uniform Resource Locators), buttons etc.) and/or RCS quick actions (graphical elements which make it possible to open a card, share location, make a telephone call, add an entry into a calendar etc.).

Alternatively or additionally, the management rules and the associated actions may be obtained from a server located in the network (which is not shown).

The management rules may comprise conditions linked to the context (location, battery level, data obtained from the user, speed etc.) of the vehicle into which the terminal 102 is integrated (alternatively, which is associated with the terminal 102).

Concretely, the management rules may be:
the presence or absence of the vehicle 102 in a particular area (for example, an area of one kilometre in diameter having the charging station 101 at its centre);
the user of the vehicle entering or not entering, on a human-machine interface of the dashboard 102, a datum which makes it possible to attest to the proximity of the vehicle to the charging station 101 (for example, the identifier of the station 101);
the vehicle reaching a threshold, for example a speed threshold or a state-of-charge threshold for the batteries of the vehicle;
reaching a predefined period;
selecting a URL/URI;
etc.

Furthermore, the management rules may be independent of the context of the vehicle into which the terminal 102 is integrated (alternatively, which is associated with the terminal 102). For example, a management rule may comprise a duration to be counted down (in seconds, in minutes or in hours).

According to one particular embodiment, a management rule may comprise conditions relating to the hardware features of the terminal 102 (for example, the features of the screen (resolution, size etc.) of the terminal 102). This implementation makes it possible, for example, for the terminal 102 to display a dialogue datum (associated action) in a particular way depending on the result of the evaluation of such a management rule (definition and size of the graphical elements, colour to be complied with depending on the screen of the terminal 102 etc.).

The associated actions may be the sending of a message to the conversational agent, a payment performed on a third-party platform (which is not shown), the rendering of content (an image and/or a video and/or a text transmitted or not transmitted with the management rule) or any other action which is able to be performed by the dashboard of the vehicle 102. When content is rendered (verbally and/or graphically), the content may correspond to selectable/clickable graphical elements (URLs (Uniform Resource Locators), buttons etc.) and/or RCS quick actions (graphical elements which make it possible to open a card, share location, make a telephone call, add an entry into a calendar etc.).

Obviously, the management rules may be combined, reiterated and/or sequenced over time. For example, a management rule/action pair may be the sending of a message to the conversational agent 101 when the speed of the vehicle 102 is equal to zero and when the user of the vehicle enters, on a human-machine interface of the dashboard 102, a datum which makes it possible to attest to the proximity of the vehicle to the charging station 101.

According to one particular embodiment, the one or more management rules and the one or more associated actions may be added to the RCS vocabulary which makes it possible to define the logics of the conversational agents.

In the step 301, the method obtains one or more results of the evaluation of the management rules which are obtained during the step 300.

According to one particular embodiment, these results may be obtained from the operating system of the vehicle (for example, via the geofencing functionality of the Android system). According to one particular embodiment, the method performs the evaluations itself. In the case where the management rule corresponds to the presence or absence of the vehicle 102 in a particular area, the method evaluates, by virtue of the GPS coordinates of the car 102, whether the car is present in the area in question. Thus, the method may, when the area corresponds to an area of one kilometre in diameter having the charging station 101 at its centre, determine whether the car 102 is or is not in proximity to the charging station 101.

Obviously, this embodiment requires the dashboard 102 to query the operating system of the vehicle (underlying terminal of the client), for example through a dedicated API (application programming interface) for each type of information (source of geolocation data, source of UWB (ultra-wideband) data, source of speed data etc.), or through a software and/or hardware component which aggregates all the potentially available information.

According to one variant of this particular embodiment, the context information for the vehicle which makes it possible for the processing method to perform the evaluation of the management rules is obtained from a third-party terminal such as a smartphone or a smartwatch (which is not shown).

According to one particular embodiment, in the case where the management rule corresponds to the detection of the station 101 by the vehicle 102 (proximity), the method may obtain, via a near-field technology, an identifier of the charging station 101 attesting to such proximity. The identifier is, for example, obtained via Wi-Fi®, Bluetooth®, NFC® (near-field communication), Zigbee®, QR code (quick-response code), IrDA (Infrared Data Association) technology etc.

According to one particular embodiment, in the case where the management rule corresponds to a duration to be counted down (for example, a duration of 30 minutes before the vehicle arrives at its destination), the method may obtain the coordinates of the destination, the traffic data associated with the route and the data associated with the driver (driving style) in order to determine the instant at which to trigger the countdown.

Alternatively or additionally, the user may perform the evaluations of the management rules and report the results on a human-machine interface of the terminal 102. Obviously, the rules are previously rendered on a human-machine interface of the terminal 102. Thus, the user may, for example, attest to the proximity of the car 102 to the charging station 101 by (verbally and/or textually) reporting information, such as an identifier inscribed on the charging station 101. Note that the result of the evaluation of the management rule by the user may be purely declarative.

According to one particular embodiment, the user has the option of (verbally and/or textually) declining to evaluate a management rule (the user is, for example, occupied). Thus, the result of the evaluation may correspond to a predefined datum such as “cancel” or “abandon”.

In that case, an error message is sent by the dashboard 102 to the conversational agent of the station 101.

According to one particular embodiment, a predefined obtainment period (in seconds or in minutes) is associated with obtaining a result of an evaluation of a management rule. When the period is exceeded, an error message is sent to the conversational agent of the station 101 by the dashboard 102.

According to one particular embodiment, confirmation/consent is requested from the user by the method when one of the management rules has to be evaluated.

According to one particular embodiment, if the management rule requests access to a sensitive context datum for the vehicle (location, speed etc.), the user may previously confirm, via a human-machine interface of the dashboard 102, that this datum is obtained then used by the method when evaluating the management rule. This confirmation may, for its part, be requested when the management rule is evaluated or before the management rule is evaluated.

Note that the confirmation may occur verbally, textually, via selecting a particular graphical element displayed on a screen of the terminal 102 or via any other means which makes it possible for the user to specify their choice (confirmation or not). Note also that the choice of the user may be stored by the method in a digital memory space, for example a database of the terminal 102.

According to a first variant of this implementation, a graphical and/or sound element is rendered to the user by the method (i.e. the dashboard 102) when the sensitive datum is being acquired. For example, a predefined pictogram is displayed on the screen of the dashboard, indicating that the vehicle is being located. This makes it possible for the user to see explicitly that the method is obtaining location data for the vehicle.

According to a second variant of this implementation, the consent may alternatively or additionally correspond to consent of the user to the use of a type of conversational agent and/or to a particular conversational agent (for example, the agent 101).

During the step 302, when a management rule is complied with, the method executes the one or more actions associated with the management rule. For example, the method may send a message to the conversational agent in order to reserve a charging slot at the station 101. The action may also comprise rendering a datum (text, image, video, RCS rich card) to the user via a human-machine interface of the terminal 102.

According to one particular embodiment, in the case where the management rule comprises a predefined period of execution of the associated action or where it takes a long time to evaluate the management rule, the execution of the action may be cancelled after a cancellation message is received from the conversational agent.

According to one particular embodiment, the method may, furthermore, obtain, during the step 300, a description datum associated with a management rule. This description datum may then be rendered to the user by a human-machine interface of the dashboard 102. This description datum makes it possible, for example, to give the user indications and/or explanations linked to the action and/or the associated management rule. Concretely, the description datum may comprise a text, an image, a video (for example, an RCS (Rich Communication Services) rich card).

According to one particular embodiment, the description datum may also comprise a cryptographic datum such as a certificate, a signature, an encryption key, a cryptographic challenge, etc.

This embodiment makes it possible to identify the conversational agent with certainty or to make the reception of the messages from the conversational agent secure. Thus, this implementation makes it possible to avoid attacks referred to as “man-in-the-middle attacks” between the terminal 102 and the conversational agent.

Note that this cryptographic datum may also be contained in the message for reserving a charging slot (step 302) and/or make it possible to generate a new cryptographic datum which may also be contained in the message for reserving a charging slot (step 302). This embodiment makes it possible to identify the terminal 102 with certainty and/or to make the messages sent to the conversational agent by the terminal 102 secure.

According to one particular embodiment, the description datum may comprise a graphical and/or sound element rendered to the user by the method (i.e. the dashboard 102) when the management rule requires the use of a sensitive datum (personal datum of the user such as their identity, their location etc.). For example, the description datum may comprise a predefined pictogram to be displayed on the screen of the dashboard, indicating that the evaluation of the management rule requires the use of the location of the vehicle. Note that this pictogram may be rendered to the user with the dialogue datum received during the step 300.

According to one particular embodiment, confirmation/consent is requested from the user by the method prior to the execution of the one or more actions associated with the management rule.

It goes without saying that the embodiment which was described above was given purely indicatively and in no way limitingly, and that many modifications may easily be made by a person skilled in the art without, however, departing from the scope of the disclosure and/or the appended claims. According to other particular embodiments of the disclosure, the disclosure also applies to a conversational agent which is able to manage a car wash machine or a (barrier, payment) machine of a private car park, and more generally to any type of conversational agent.

What is claimed is:

1. A method for processing a message received by an electronic client from a conversational agent, said method being implemented by a processing device and comprising:
obtaining, from said conversational agent, said message comprising at least one management rule and at least one associated action; and
executing said at least one associated action depending on a result of at least one evaluation of said at least one management rule.

2. The method according to claim 1, wherein said evaluation of said at least one management rule is carried out depending on at least one context datum for said client.

3. The method according to claim 1, wherein said at least one result is obtained from a second human-machine interface of said client after said at least one management rule is rendered through a first human-machine interface of said client.

4. The method according to claim 1, wherein said at least one evaluation is conditioned by a result of a confirmation step performed by a user through a human-machine interface of said client.

5. The method according to claim 1, wherein the obtaining further comprises obtaining at least one description datum for said at least one management rule.

6. The method according to claim 1, wherein the executing said at least one action is conditioned by a result of a confirmation step performed by a user through a human-machine interface of said client.

7. The method according to claim 1, wherein said message is Rich Communication Services (RCS) message which is compliant with the GSM Association (GSMA) FNW.11 standard.

8. A device for processing a message received by an electronic client from a conversational agent, wherein the device comprises:
at least one processor; and
at least one computer readable medium comprising instructions stored thereon which when executed by the at least one processor configure the device to:
obtain, from said conversational agent, said message comprising at least one management rule and at least one associated action; and
execute said at least one associated action depending on a result of at least one evaluation of said at least one management rule.

9. The device according to claim 8, wherein the device is implemented in a terminal comprising the electronic client.

10. The device according to claim 8, wherein the device is implemented in a vehicle comprising the electronic client.

11. A non-transitory computer readable medium comprising a computer program stored thereon comprising instructions for implementing a method of processing a message received by an electronic client from a conversational agent, when the program is executed by a processor, wherein the method comprises:
obtaining, from said conversational agent, said message comprising at least one management rule and at least one associated action; and
executing said at least one associated action depending on a result of at least one evaluation of said at least one management rule.
